(19) United States
(12) Patent Application Publication
(10) Pub. No.: US 2016/0239870 A1
(43) Pub. Date: Aug. 18, 2016

(54) Automated Consumer Engagement

(71) Applicant: Offerpop Corporation, New York, NY (US)

(72) Inventors: Prakash Mishra, Stamford, CT (US); Wendell Lansford, New York, NY (US)

(73) Assignee: Offerpop Corporation, New York, NY (US)

(21) Appl. No.: 15/046,127

(22) Filed: Feb. 17, 2016

Related U.S. Application Data
(60) Provisional application No. 62/117,023, filed on Feb. 17, 2015.

(51) Int. Cl. G06Q 30/02

(52) U.S. Cl. CPC G06Q 30/0257

(57) ABSTRACT

A computer system enables automated consumer engagement by an organization. An electronic communication of the consumer may be determined to satisfy a predetermined criterion. For example, it may be determined that the electronic communication contains a particular hashtag indicating affinity with a brand of the organization. A request for authorization by the consumer to transmit future communications to the consumer may be transmitted to the consumer. In response to receiving authorization, a communication representing an incentive may be transmitted to the consumer.

### BACKGROUND

Conventional computerized engagement (or “electronic engagement”) of a consumer by an organization typically involves a call to action followed by the consumer taking computerized steps to opt in. At a physical location of the organization, the consumer may see a communication asking the consumer to electronically opt into future communications from the organization (the “call to action”). If the consumer takes the necessary steps to electronically opt into future communications, the organization may thereafter send future communications to the consumer.

Consider the following exemplary scenario involving a restaurant and one of its consumers. At a physical location of the restaurant, the consumer may see a poster asking consumers to join an email list of the restaurant (i.e., a call to action by the restaurant). The consumer may then join the email list of the restaurant by, e.g., visiting a website of the restaurant and using an online form to sign up to receive future communications from the restaurant. The online form may ask for contact information of the consumer, as well as additional data about the consumer such as demographic information. The purpose for engaging a consumer is, e.g., to gain the consumer's data so that targeted advertising may be communicated to the consumer in order to drive the consumer to purchase more from the restaurant.

Conventional computerized engagement of consumers, however, has its drawbacks. For example, the consumer may simply ignore or forget the call to action. Due to these and other drawbacks, conventional computerized engagement of consumers may have low effectiveness rates.

### SUMMARY

A computer system enables automated consumer engagement by an organization. An electronic communication of the consumer may be determined to satisfy a predetermined criterion. For example, it may be determined that the electronic communication contains a particular hashtag indicating affinity with a brand of the organization. A request for authorization by the consumer to transmit future communications to the consumer may be transmitted to the consumer. In response to receiving authorization, a communication representing an incentive may be transmitted to the consumer.

For example, one embodiment of the present invention is directed to a computer-implemented method comprising: (A) determining that a particular electronic communication of a particular user satisfies a predetermined criterion; (B) in response to the determining that the particular electronic communication of the particular user satisfies the predetermined criterion, transmitting a request for authorization by the particular user to transmit future communications to the user; (C)receiving, from a device of the particular user, said authorization; and (D) transmitting a communication representing an incentive in response to the receiving of said authorization.

The computer-implemented method may further include, before the determining, determining whether a plurality of electronic communications of a plurality of users satisfy the predetermined criterion. The plurality of electronic communications may include the particular electronic communication, and the plurality of users may include the particular user.

The transmitting of the request for authorization may comprise transmitting the request for authorization by the particular user to transmit future communications to the user related to the predetermined criterion.

The determining may comprise determining that a tag in the particular electronic communication satisfies the predetermined criterion.

The determining may comprise determining that a hashtag in the particular electronic communication satisfies the predetermined criterion.

The determining may comprise determining that a keyword in the particular electronic communication satisfies the predetermined criterion.

The transmitting of the request for authorization may comprise transmitting the request to the device of the particular user.

The particular electronic communication of the particular user may include an identifier of the particular user. The transmitting of the request for authorization may comprise transmitting the request for authorization to the particular user using the identifier of the particular user.

Operation (B) may further comprise: (B) (1) before said transmitting of the request for authorization, transmitting a communication representing a call to action to the particular user; (B) (2) receiving, from the device of the particular user, a communication representing a response to the call to action; and, (B) (3) in response to the communication representing the response to the call to action, transmitting said request for authorization.

Operation (B) may further comprise (B) (4) after said receiving of the communication representing the response to the call for action, determining that a login by the particular user to an existing social media system has been successful.

Operation (C) may further comprise (C) (1) receiving information in addition to said authorization. The communication representing the incentive may be generated and/or selected based on said information.

Operation (D) may further comprise transmitting, to the device of the particular user, the communication representing the incentive in response to the receiving of said authorization.

The particular electronic communication may comprise a social media post.

The social media post may comprise an image file or a multimedia file. The hashtag may be in text associated with the image file or the multimedia file.

The social media post may comprise an image file or a multimedia file. The hashtag is identified in metadata associated with the image file or the multimedia file.

The particular electronic communication may comprise an email message.

The particular electronic communication may comprise a text message.

The particular electronic communication comprises a social media private message.

The determining that the particular electronic communication of the particular user satisfies the predetermined criterion may comprise determining that the particular electronic communication includes a predetermined brand identifier.

Another embodiment of the present invention is directed to a computer-implemented method, comprising: (A) determining that a particular user among a plurality of users has submitted an electronic communication to an existing social media system; (B) determining that a hashtag within the electronic communication of the particular user includes a predetermined brand identifier or slogan; (C) in response to the determining that the hashtag includes the predetermined brand identifier or slogan, transmitting a communication representing a call to action to the particular user; (D) receiving, from a device of the particular user, a communication representing a response to the call to action; (E) determining that a login by the particular user to the existing social media system has been successful; (F) transmitting a request for authorization by the particular user to transmit future communications to the particular user; (G) receiving, from the device of the particular user, said authorization; and (H) transmitting a communication representing an incentive in response to the receiving of said authorization.

Operation (G) may further comprise: (G) (1) receiving information in addition to said authorization. The communication representing the incentive is generated and/or selected based on said information.

Other features and advantages of various aspects and embodiments of the present invention will become apparent from the following description and from the claims.

### BRIEF DESCRIPTION OF THE DRAWINGS

FIG. 1 is a schematic representation of a system for automated consumer engagement according to one embodiment of the present invention;

FIG. 2 is a dataflow diagram according to one embodiment of the present invention;

FIG. 3 is a flowchart of a method according to the embodiment of FIG. 2;

FIG. 4 is a dataflow diagram according to another embodiment of the present invention; and

FIG. 5 is a flowchart of a method according to the embodiment of FIG. 4.

### DETAILED DESCRIPTION

In general, embodiments of the present invention include techniques for enabling automated consumer engagement by an organization. An electronic communication of the consumer may be determined to satisfy a predetermined criterion. For example, it may be determined that the electronic communication contains a particular hashtag indicating affinity with a brand of the organization. A request for authorization by the consumer to transmit future communications to the consumer may be transmitted to the consumer. In response to receiving authorization, a communication representing an incentive may be transmitted to the consumer. In this way, an improved effectiveness rate of consumer engagement may be achieved.

It is to be understood that the term “consumer” should not be read as limiting the present invention. “Consumers” may include a wide variety of entities, such as customers, clients, patients, and the like.

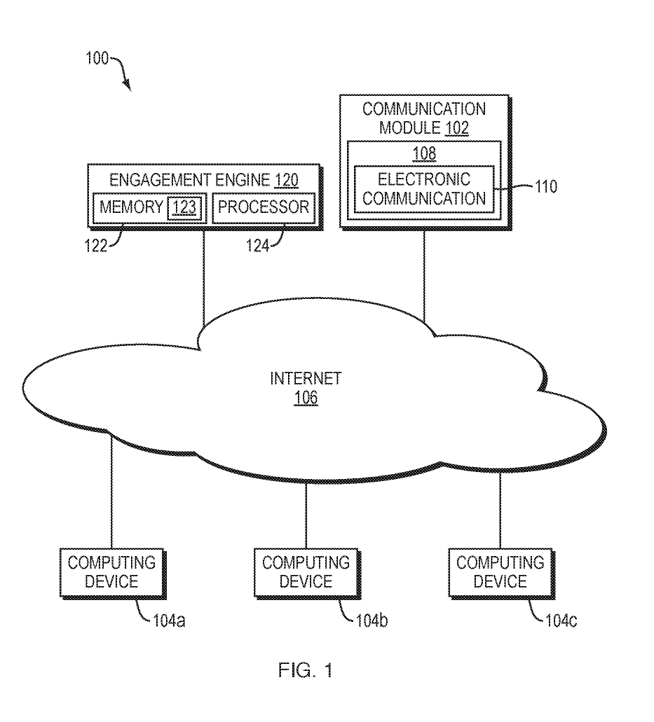

For example, referring to FIG. 1, a schematic representation is shown of a system 100 for automated consumer engagement according to one embodiment of the present invention. The system 100 may include a communication module 102, which is accessed by a plurality of user devices 104a-c to enable users to generate electronic communications, such as social media posts, instant messages such as social media private messages, email messages, text messages (SMS, MMS, or other mobile device messages) and the like. The system 100 may further include an engagement engine 120. Although one communication module 102, one engagement engine 120, and three user devices 104a-c are shown in FIG. 1 for purpose of example, the system 100 may include any number of communication modules 102, engagement engines 120, and user devices 104a-c.

The communication module 102 may be any kind of module for creating, posting, modifying, deleting, and otherwise managing communications, such as a social media server, a text messaging server, a chat server, an email server, a Voice over IP (VoIP) server, or any portion or combination thereof. These particular types of communication are merely examples and do not constitute limitations of the present invention. More generally, the communication module 102 may be capable of creating, posting, modifying, deleting, or otherwise managing any type of communication.

Each of the computing devices 104a-c may be any kind of computing device, such as a desktop computer, laptop computer, tablet computer, or smartphone.

The engagement engine 120 may be any kind of computerized system for receiving, copying, parsing, and/or otherwise managing electronic communications to and from the communication module 102 (such as identify verification communications); and for creating communications and transmitting the communications to the user devices 104a-c, receiving responses to communications from the user devices 104a-c, and/or otherwise managing communications to and from the user devices 104a-c.

In general, user devices 104a-c may provide any of a variety of inputs to the communication module 102, such as input specifying a new electronic communication to create and post, input indicating that a particular electronic communication should be manifested (e.g., displayed or shown), input modifying a particular electronic communication (e.g., editing an existing post), input instructing the communication module 102 to delete a particular electronic communication, or the like. The communication module 102 may provide any of a variety of outputs to the user devices 104a-c, such as output representing the contents of a particular electronic communication.

In general, the communication module 102 may provide any of a variety of outputs to the user devices 104a-c, such as output representing the contents of a particular electronic communication.

Inputs and outputs may be transmitted over one or more networks, such as network 106 (which may, for example, be the public Internet, a private intranet, or a combination thereof).

Consider, for purposes of example, that input received from user 104a specifies a new electronic communication to be created. In response to receiving such input, the communication module 102 may create in a communication storage 108, a particular electronic communication 110, based on the input received from user device 104a. In this example, inputs from other user devices 104b, 104c may similarly create new electronic communications, which may be independent of or related to the particular electronic communication 110 created based on the input received from user device 104a.

In general, embodiments of the present invention may be used in connection with any kinds of electronic communications generated in any manner by any number and combination of users. Although certain embodiments of the present invention may be described herein in connection with the particular electronic communication 110 for ease of explanation, any of the techniques disclosed herein may be applied to other electronic communications not shown or described herein.

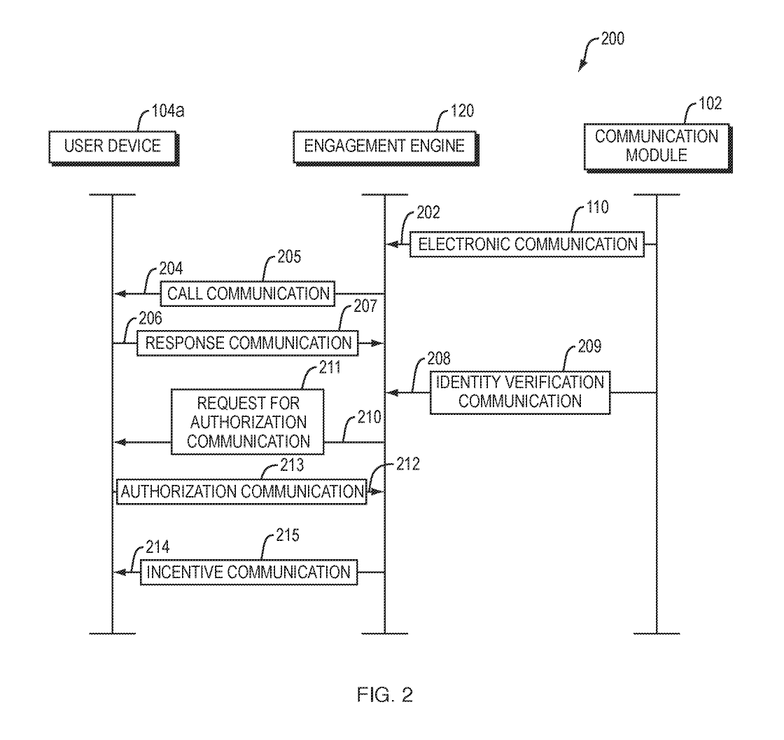

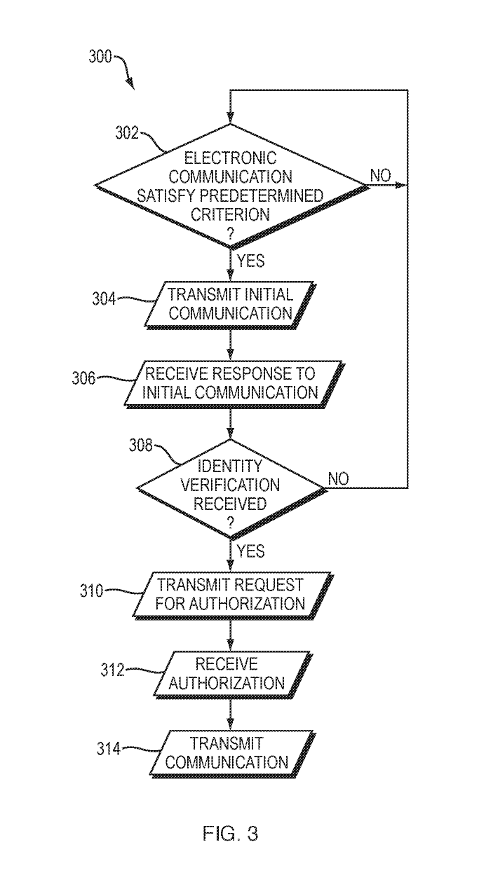

Referring to FIG. 2, a dataflow 200 diagram is shown of the flow of data through the system 100 of FIG. 1 according to one embodiment of the present invention. Referring to FIG. 3, a flowchart is shown of a method 300 that is performed by the system 100 of FIG. 1 according to one embodiment of the present invention. The engagement engine 120 may receive as input 202 the particular electronic communication 110 (or a copy thereof) from the communication module 102.

In operation 302 of the method 300 of FIG. 3, the engagement engine 120 may determine whether the particular electronic communication of a user via user device 104a satisfies a predetermined criterion (represented by predetermined criterion data 123 stored in memory 122). The determination made by the engagement engine 120 may be made, for example, by parsing the particular electronic communication 110 (or a copy thereof) into one or more tokens and reviewing the resulting token(s) for a predefined component. For example, the engagement engine 120 may determine whether a tag, a hashtag, and/or a keyword in the particular electronic communication 110 satisfies the predetermined criterion (e.g., is present within the particular electronic communication 110). As another example, the engagement engine 120 may determine whether the particular electronic communication 110 contains a predetermined brand identifier. As further examples, the engagement engine 120 may determine whether the particular electronic communication 110 contains (or is associated with) any one or more of the following: an addressee, geographic location information, timing information, an attached file (e.g., a photo, a video), a link (e.g., a hyperlink), information representing a sentiment (e.g., a positive sentiment or a negative sentiment) of the sender of the particular electronic communication 110 (e.g., the user of the device 104a), and known or derivable user information (e.g., any information contained in or derived from a social media profile of the user of the device 104a, such as the user's number of social media followers or friends).

It is to be understood that the predetermined criterion may serve as an indicator that the user is opting-in to participate, or indicating an interest in participating in receiving incentive communications. For example, the predetermined criterion may be whether the particular electronic communication contains the hashtag, e.g., “#*FreeOffer” or the keywords, e.g., “Sign me up” or “I want free shipping”. Such a predetermined criterion may signal to the engagement engine that a user would like future incentive communications.

It is to be understood that data and/or actions other than electronic communications may be analyzed to determine whether said action indicates brand affinity. For example, data representing a purchase at a particular restaurant may indicate an affinity of the user for brand.

It is to be understood that before or as part of operation 302, the engagement engine 120 may determine whether a plurality of electronic communications of a plurality of users satisfy the predetermined criterion. The plurality of electronic communications may include the particular electronic communication, and the plurality of users may include the particular user.

If, during operation 302, it is determined that the particular electronic communication 110 of the user device 104a does not satisfy the predetermined criterion, the method 300 may return again to operation 302. If, during operation 302, it is determined that the particular electronic communication 110 of the user device 104a satisfies the predetermined criterion, the method 300 may proceed to operation 304.

In operation 304, an initial communication may be output 204 from the engagement engine 120 to the user device 104a. For example, a call communication 205 representing a call to action may be transmitted to the user device 104a. After operation 304, the method 300 may proceed to operation 306.

In operation 306, a response communication 207 in response to the call communication 205 may be received as input 206 into the engagement engine 120 from the user device 104a. For example, a response communication 207 representing a response to a call for action may be received from the user device 104a. Accordingly, a user may respond to the call communication 205 with the response communication 207 quickly and easily after receiving a call to action, thereby increasing the likelihood that the user will respond to such a call to action. It should be understood that as with other communications described herein, the response communication 207 may be directly received by the engagement engine 120, or alternatively may be obtained by the engagement engine 120 scanning one or more external systems (e.g., a social media system) and pulling the response communication 207 therefrom.

After operation 306, the engagement engine 120 may receive as input 208 an identity verification communication 209 from the communication module 102 and the method 300 may proceed to operation 308. As with the other operations, the timing and order of the operations may be varied and still fall within the scope of the present invention. For example, the communication in response to the initial communication may be simultaneously or near simultaneously received with the identity verification communication 209.

In operation 308, the engagement engine 120 may determine whether the identity verification communication 209 was received from the communication module 102. The engagement engine 120 may determine that the user's identity has been confirmed in response to determining that the identity verification communication 209 was received from the communication module 102. For example, the engagement engine 120 may determine that confirmation of user login to the communication module has occurred. As another example, the engagement engine 120 may receive confirmation of user login to an existing social media system. As another example, the engagement engine 120 may receive confirmation of sharing of a user social media profile with the system 100.

If, during operation 308, it is determined that the identify verification communication 209 was not received from the communication module 102, the method 300 may return to operation 302. If, during operation 308, it is determined that the identify verification communication 209 was received from the communication module 102, the method 300 may proceed to operation 310.

In operation 310, a request for authorization communication 211 representing a request for authorization may be output 210 from the engagement engine 120 to the user. For example, the request for authorization communication 211 may be output 210 from the engagement engine 120 to the user device 104a. The request for authorization may be a request, to the user, for authorization to transmit, to the user, future communications, such as product and service offers or the like. The future communications may be related to the predetermined criterion. The particular electronic communication 110 may include an identifier of the particular user, such as social media service username, an email address, or the like. The engagement engine 120 may obtain the identifier of the particular user from the particular electronic communication 110 and transmit the request for authorization communication 211 to the user via the identifier of the particular user, such as by using the identifier of the particular user as a recipient identifier (e.g., the contents of the “To” field in an email message) in the request for authorization communication 211. The method 300 may proceed to operation 312.

In operation 312, an authorization communication 213 representing authorization in response to the request for authorization communication 211 may be received as input 212 into the engagement engine 120 from the user device 104a. Additional information, such as demographic information of the user, may also be received in addition to, or as part of, the authorization communication 213. If an authorization communication 213 is not received in response to the request for authorization communication 211 (i.e., if authorization is not given), the method 300 may return to operation 302. Otherwise, after receiving the authorization communication 213, the method 300 may proceed to operation 314.

In operation 314, an incentive communication 215 representing an incentive may be transmitted 214 to the user device 104a from the engagement engine 120. The incentive communication 215 may be generated or selected based on the additional information received by the engagement engine 120, such as demographic information. For example, if demographic information indicates that the user lives in a multi-member family, an incentive communication 215 noting an organization's “family night” may be selected for transmission. As another simple example, if demographic information indicates that the user is 50 years old, an incentive communication 215 may be generated reading “Enjoy being 50 and have a free dessert on us!” As another simple example, the content of the incentive communication 215 may be selected/generated to be relatively more aggressive to a customer who has lapsed than to a current customer. As yet another simple example, the content of the incentive communication 215 may be selected/generated based on the user's buying history.

In general, embodiments of the present invention may include a user profile database which may contain any of the user information disclosed herein, such as user demographic information and/or user social media profile information. Elements of embodiments of the present invention, such as the engagement engine 120, may access the user profile database to obtain any user information disclosed herein. Element of embodiments of the present invention, such as the engagement engine 120, may also add and/or update information in the user profile database. For example, after the engagement engine 120 sends the call communication 405 to the user device 104a, the engagement engine 120 may store data, in the record associated with the user device 104a (or with the user of the user device 104a), indicating that the call communication 405 has been sent to the user device 104a.

It is to be understood that the simple examples listed above are provided in the interest of brevity. Alternative and additional incentive communication 215 generation and selection is considered within the scope of the present invention. Further, it is to be understood that “representing an incentive” should be broadly interpreted to include where the communication itself includes the incentive (such as a digital coupon), where the communication includes a link to the incentive (such as a hyperlink), where the communication includes a code that must be provided as input by the user to be redeemed, or the like. Alternatively to the communication being sent to the user device 104a, a communication representing an incentive may be transmitted to a user, e.g., via a telephone call. For example, an automated message including an incentive or coupon code may be transmitted to the user.

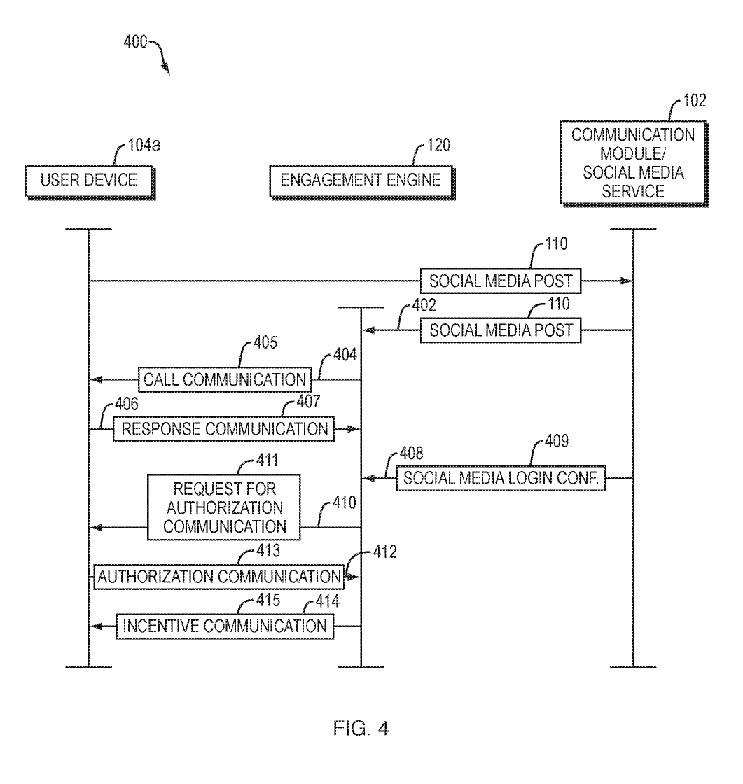

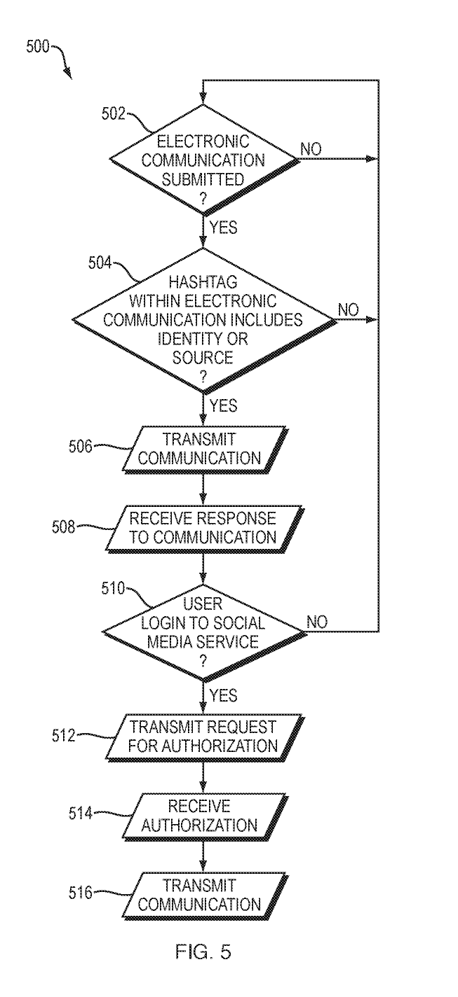

Referring now to FIG. 4, a dataflow 400 diagram is shown of the data flow through the system 100 of FIG. 1 according to another embodiment of the present invention. Referring to FIG. 5, a flowchart is shown of a method 500 that is performed according to another embodiment of the present invention.

At a physical location of an organization, a consumer may see a communication asking the user to submit a social media post indicating the consumer's affinity with a particular brand. Consider the following exemplary restaurant scenario. A poster may be displayed at a Chili's restaurant stating “Tweet a photo with our hashtag #ilovechilis and get a free desert.” The consumer may use user device 104a to post a social media post (e.g., a Tweet) to a user space (e.g., a Twitter profile) of a social media service (e.g., Twitter) for other social media users to view (e.g., on their Twitter home page). The engagement engine 120 may receive as input 402 the social media post (or a copy thereof) as the electronic communication 110 from the communication module 102 of the social media service.

For example, in operation 502 of the method 500 of FIG. 5, the engagement engine 120 may determine whether the social media post as the particular electronic communication 110 has been submitted to the communication module 120 of the social media service. If, during operation 502, it is determined that the social media post has not been submitted to the social media service, the method 500 may return again to operation 502. If, during operation 502, it is determined that the social media post has been submitted to the social media service thereby causing a copy of the social media post to be received as input 402 by the engagement engine, the method 500 may proceed to operation 504.

Note that, as the above description illustrates, the particular electronic communication 110 may be an electronic communication, such as a Twitter tweet, that does not have any designated recipient. Instead, the particular electronic communication 110 may be an electronic communication that is posted publicly, such that the particular electronic communication 110 is accessible by anyone or by anyone who is authorized to access a particular network (e.g., social media service), rather than only by one or more enumerated recipients of the particular electronic communication 110. As another example, the particular electronic communication 110 may have one or more designated recipients, but the engagement engine 120 may access the particular electronic communication 110 without accessing or being authorized to access an account of any of those designated recipients. The engagement engine 120 may scan a plurality of electronic communications, such as a plurality of electronic messages posted publicly or semi-publicly by one or more users to one or more accounts of a social media service (e.g., a plurality of tweets posted to Twitter), to identify one or more particular electronic communications which satisfy one or more predetermined criteria. As a result, users need not address their electronic communications to any predesignated recipient for the engagement engine 120 to access such electronic communications and to determine whether such electronic communications satisfy one or more predetermined criteria, such as any of the predetermined criteria disclosed herein.

In operation 504, the engagement engine 120 may determine whether the social media post of the user device 104a contains a predetermined hashtag. The determination made by the engagement engine may be made by, for example, parsing the social media post (or a copy thereof) into one or more tokens and reviewing the resulting tokens for a predefined hashtag. In the exemplary restaurant scenario, the social media post may be parsed to find a portion containing “#ilovechilis”.

If, during operation 504, it is determined that the social media post of the user device 104a does not contain the predefined hashtag, the method 500 may return to operation 502. If, during operation 504, it is determined that the social media post of the user device 104a does contain the predefined hashtag, the method may proceed to operation 506.

In operation 506, a call communication 405 representing a call to action may be output 404 from the engagement engine 120 to the user device 104a. In the exemplary restaurant scenario, a call communication 405 sent from a Chili's social media account (and therefore appearing to be sent by Chili's, whether or not the communication actually is sent by an employee of Chili's) may be sent to the user device 104a. The communication may, for example, read “Click here to get your free desert.” The method may proceed to operation 508.

In operation 508, a response communication 407 in response to the communication representing the call to action may be received as input 406 into the engagement engine 120 from the user device 104a. In the exemplary restaurant scenario, the user may click on the communication reading “Click here to get your free desert” thereby generating the response communication 407.

After operation 508, the engagement engine 120 may receive as input 408 social media service login verification 409 and the method 500 may proceed to operation 510. As with the other operations, the timing and order of the operations may be varied and still fall within the scope of the present invention. For example, the response communication 407 in response to the call communication 405 representing the call to action may be simultaneously or near simultaneously received with the social media service login verification 409.

In operation 510, the engagement engine 120 may determine whether the social media service login verification 409 was received from the social media service. In the exemplary restaurant scenario, confirmation of a successful Twitter login may be received from Twitter.

If, during operation 510, it is determined that a social media service login verification 409 was not received from the social media service, the method 500 may return to operation 502. If, during operation 510, it is determined that the social media service login verification 409 was received from the social media service, the method 500 may proceed to operation 512.

In operation 512, a request for authorization communication 411 representing a request for authorization may be output 410 from the engagement engine 120 to the user device 104a. The request for authorization communication 411 may be a request, to the user, for authorization to transmit, to the user, future communications, such as product and service offers, or the like. The method 500 may proceed to operation 514.

In operation 514, an authorization communication 413 representing authorization in response to the request for authorization communication 411 may be received as input 412 to the engagement engine. Information in addition to said authorization may also be received, such as demographic information in response to, e.g., a survey. Such demographic information may be used in targeting product and service offers, or the like. If an authorization communication 413 is not received in response to the request for authorization communication 411 (i.e., if authorization is not given), the method 500 may return to operation 502. Otherwise, the method 500 may proceed to operation 516.

In operation 516, an incentive communication 415 representing an incentive may be output 414 from the engagement engine 120 to the user device 104a. In the exemplary restaurant scenario, an incentive communication 415 serving as or containing a coupon for a free desert may be communicated to the user device 104a.

Embodiments of the present invention have a variety of advantages, such as the following. Conventional computerized engagement of a consumer by an organization through a conventional opt in process may have a low effectiveness rate. For example, a consumer may simply ignore or forget a call to action by the organization (e.g., a poster asking consumers to join an email list of the organization). Embodiments of the present invention address these problems by providing automated consumer engagement by an organization. An electronic communication of a consumer may be determined to satisfy a predetermined criterion. A request for authorization by the consumer to transmit future communications to the consumer may be transmitted to the consumer. In response to receiving authorization, a communication representing an incentive may be transmitted to the consumer. In this way, an improved effectiveness rate of consumer engagement may be achieved.

In particular, embodiments of the present invention may provide a call to action to which users may respond quickly and easily, such as by posting a message to a social networking site. For example, a user may see a call to action while in line at a restaurant and respond to the call to action essentially immediately (e.g., within a few seconds, one minute, or five minutes) and while still at the restaurant, such as by posting a message to a social networking site using a smartphone or other Internet-connected mobile device. Embodiments of the present invention may receive or otherwise obtain some or all of the user's response message, and detect that such a message is a response to the call to action, such as by determining that the message satisfies a predetermined criterion (e.g., contains a particular hashtag). In this way, embodiments of the present invention enable users to respond to call to action quickly after receiving such calls to action, and with minimal effort. As a result, embodiments of the present invention increase the likelihood that users will respond to such calls to action, and reduce the delay between receipt of such calls to action by users and receipt of responses from users to such calls to action.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A computer-implemented method, comprising:
(A) determining that a particular electronic communication of a particular user satisfies a predetermined criterion;
(B) in response to the determining that the particular electronic communication of the particular user satisfies the predetermined criterion, transmitting a request for authorization by the particular user to transmit future communications to the user;
(C) receiving, from a device of the particular user, said authorization; and
(D) transmitting a communication representing an incentive in response to the receiving of said authorization.

2. The computer-implemented method of claim 1, further comprising:
before said determining, determining whether a plurality of electronic communications of a plurality of users satisfy the predetermined criterion, wherein the plurality of electronic communications include the particular electronic communication, and wherein the plurality of users includes the particular user.

3. The computer-implemented method of claim 1, wherein the transmitting of the request for authorization comprises transmitting the request for authorization by the particular user to transmit future communications to the user related to the predetermined criterion.

4. The computer-implemented method of claim 3, wherein said determining comprises determining that a tag in the particular electronic communication satisfies the predetermined criterion.

5. The computer-implemented method of claim 3, wherein said determining comprises determining that a hashtag in the particular electronic communication satisfies the predetermined criterion.

6. The computer-implemented method of claim 3, wherein said determining comprises determining that a keyword in the particular electronic communication satisfies the predetermined criterion.

7. The computer-implemented method of claim 1, wherein the transmitting of the request for authorization comprises transmitting the request to the device of the particular user.

8. The computer-implemented method of claim 1, wherein the particular electronic communication of the particular user includes an identifier of the particular user, and wherein the transmitting of the request for authorization comprises transmitting the request for authorization to the particular user using the identifier of the particular user.

9. The computer-implemented method of claim 1, wherein (B) further comprises:
(B) (1) before said transmitting of the request for authorization, transmitting a communication representing a call to action to the particular user;
(B) (2) receiving, from the device of the particular user, a communication representing a response to the call to action; and
(B) (3) in response to the communication representing the response to the call to action, transmitting said request for authorization.

10. The computer-implemented method of claim 9, wherein (B) further comprises:
(B) (4) after said receiving of the communication representing the response to the call for action, determining that the particular user's identity has been confirmed.

11. The computer-implemented method of claim 1, wherein (C) further comprises:
(C) (1) receiving information in addition to said authorization,
wherein the communication representing the incentive is generated and/or selected based on said information.

12. The computer-implemented method of claim 1, wherein (D) further comprises transmitting, to the device of the particular user, the communication representing the incentive in response to the receiving of said authorization.

13. The computer-implemented method of claim 5, wherein the particular electronic communication comprises a social media post.

14. The computer-implemented method of claim 13, wherein the social media post comprises an image file or a multimedia file, and wherein said hashtag is in text associated with the image file or the multimedia file.

15. The computer-implemented method of claim 13, wherein the social media post comprises an image file or a multimedia file, and wherein said hashtag is identified in metadata associated with the image file or the multimedia file.

16. The computer-implemented method of claim 1, wherein the particular electronic communication comprises an email message.

17. The computer-implemented method of claim 1, wherein the particular electronic communication comprises a social media private message.

18. The computer-implemented method of claim 1, wherein the particular electronic communication comprises a text message.

19. The computer-implemented method of claim 1, wherein the determining that the particular electronic communication of the particular user satisfies the predetermined criterion comprises determining that the particular electronic communication includes a predetermined brand identifier.

20. A computer-implemented method, comprising:
(A) determining that a particular user among a plurality of users has submitted an electronic communication to an existing social media system;
(B) determining that a hashtag within the electronic communication of the particular user includes a predetermined brand identifier or slogan;
(C) in response to the determining that the hashtag includes the predetermined brand identifier or slogan, transmitting a communication representing a call to action to the particular user;
(D) receiving, from a device of the particular user, a communication representing a response to the call to action;
(E) determining that a login by the particular user to the existing social media system has been successful;
(F) transmitting a request for authorization by the particular user to transmit future communications to the particular user;
(G) receiving, from the device of the particular user, said authorization; and
(H) transmitting a communication representing an incentive in response to the receiving of said authorization.

21. The computer-implemented method of claim 19, wherein (G) further comprises:
(G) (1) receiving information in addition to said authorization,
wherein the communication representing the incentive is generated and/or selected based on said information.
